(19) United States
(12) Patent Application Publication
(10) Pub. No.: US 2024/0114199 A1
(43) Pub. Date: Apr. 4, 2024

(54) On-The-Edge Network For Generating Dynamic Digital Cinema Packages

(71) Applicant: Cielo Enterprise Solutions Inc., Miami, FL (US)

(72) Inventors: Joseph Edgar Edwards, VIII, Laramie, WY (US); Ricardo Cabrera, Miami, FL (US)

(21) Appl. No.: 18/375,247

(22) Filed: Sep. 29, 2023

Related U.S. Application Data
(60) Provisional application No. 63/411,253, filed on Sep. 29, 2022.

(51) Int. Cl. H04N 21/432; H04N 21/414; H04N 21/433; H04N 21/442; H04N 21/472; H04N 21/81

(52) U.S. Cl. CPC H04N 21/4325; H04N 21/41415; H04N 21/4331; H04N 21/4424; H04N 21/472; H04N 21/812

(57) ABSTRACT

In one embodiment, a method includes accessing, by a computing device local to a cinema, a manifest identifying dynamic content from a supply-side platform that may be placed in a digital cinema package (DCP) for that cinema during a period of time and storing, by the computing device local to the cinema, each item of dynamic content identified in the manifest for that period of time. The method further includes requesting a dynamic content item for a particular slot in a DCP for display at the cinema during the period of time; receiving an identification of a particular dynamic content item for the particular slot; accessing the identified particular dynamic content item from the dynamic content items previously stored by the computing device local to the cinema; and generating, by the computing device local to the cinema, a DCP including the particular dynamic content item to transmit to the TMS.

### PRIORITY CLAIM

This application claims priority, under 35 U.S.C. § 119, to U.S. Provisional Patent Application No. 63/411,253 filed Sep. 29, 2022, the entirety of which is incorporated by reference herein.

### TECHNICAL FIELD

This application generally relates to an on-the-edge network for generating dynamic digital cinema packages.

### BACKGROUND

A digital cinema package, or DCP, is typically the only way to play media (e.g., video and audio media) on a cinema's equipment, such as a digital projector, that plays movie-theater content. A DCP includes one or more media files for playback on a cinema's equipment, and one or more composition playlists, or CPLs, which define a particular composition for playback. For example, a CPL for a particular movie may identify the movie content to be played along with metadata about the movie, such as a title, date, and version of the movie content to be played, along with other metadata.

A DCP includes all the media files for the content specified by that DCP, such as video and audio files. Given the high-fidelity requirements of movie theaters, DCPs can be quite large and can require significant bit rates. For example, a DCP's bitrate may be around 250 Mbs per second, and the total size of a DCP for a movie may be around 200 GB.

Media content may be grouped together in a DCP, and different DCPs may be used for a particular cinema showing related to a movie. For example, a showing may include a first DCP that contains advertisements to be played before a particular movie, a second DCP that contains trailers to be played before a particular movie, and a third DCP that contains the particular movie itself.

In order to play any content using a cinema's equipment, the content must be packed as a DCP and identified by a playlist. A playlist for a cinema cannot point to individual files or CPLs, but only to CPLs within DCPs. Media content within a DCP is often represented in a .MXF file format.

### BRIEF DESCRIPTION OF THE DRAWINGS

FIG. 1 illustrates an example architecture for improving the packaging and delivery of certain digital cinema packages to a cinema.

FIG. 2 illustrates an example method for improving the packaging and delivery of certain digital cinema packages to a cinema.

FIG. 3 illustrates an example computing system.

### DESCRIPTION OF EXAMPLE EMBODIMENTS

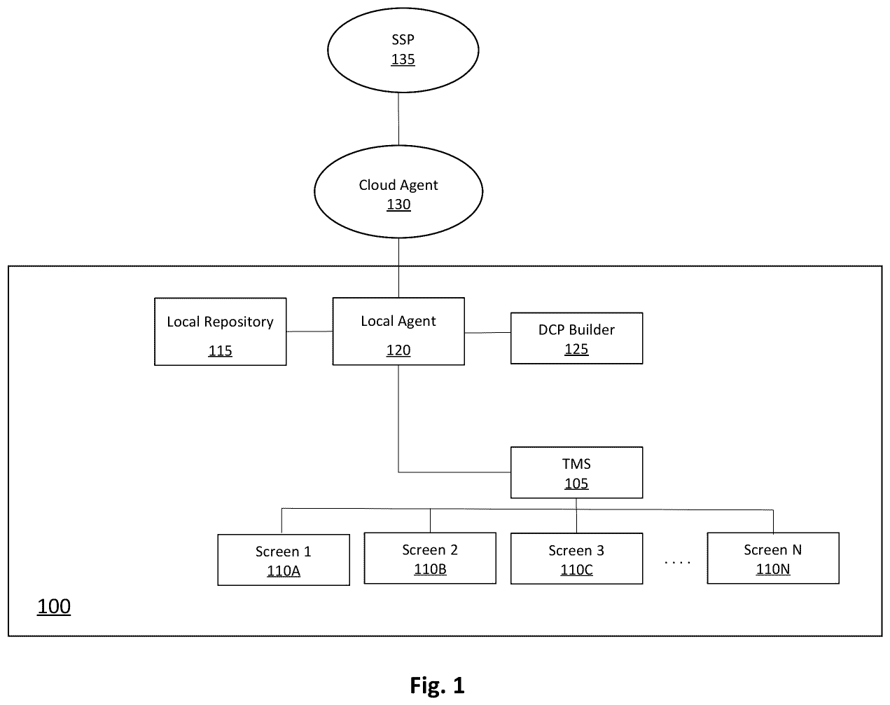

FIG. 1 illustrates an example architecture for improving the packaging and delivery of certain digital cinema packages to a cinema. FIG. 1 illustrates an example cinema 100, which includes screens 110A-N. The cinema may provide a particular showing on a particular screen. For example, each screen may provide four showings over the course of a day. Each showing typically includes a movie and some preceding content, such as advertisements and trailers for other content. The content to play for a particular showing on a particular screen in a theater is determined by that theater's show playlist (SPL), which specifies a set of digital cinema packages (DCPs) for each showing.

Content for a particular showing is typically divided into multiple DCPs. For example, one DCP may contain the advertisements for that showing, a second DCP may contain the trailers for that showing, and a third DCP may contain the movie for that showing. The exact content within a DCP is specified by one or more composition playlists (CPLs), each of which specifies a particular set of content to play. For example, a particular movie, trailer, or advertisement may each be specified by a corresponding CPL or by a reel within a CPL. A DCP with multiple content items, such as a DCP with multiple advertisements, may contain multiple CPLs or may contain multiple reels within a single CPL. In general, a CPL may contain one or more content items, and a DCP may contain one or more CPLs.

Conventionally, content within a DCP is static content, in that the content is determined well before that content is to be played at a particular showing at a cinema. For example, a particular movie may be specified well in advance of the showing. As another example, advertisements or trailers may be specified for a particular showing well in advance of that showing. As explained below, the conventional mechanisms for delivering DCPs to a cinema in-practice only permit static content, as those delivery mechanisms fix the content of a DCP weeks in advance of when the content will actually play. These conventional approaches do not allow a DCP to contain dynamic content, in which the particular content to play is determined relatively near in time to the showing (e.g., the same day, or in even less time). For example, dynamic content would permit one or more advertisement slots in a DCP corresponding to pre-movie advertisements for a particular showing to be filled the same day as the showing, for example by an ad exchange that holds an auction for the particular advertisement slot. But as explained below, this type of content is not currently available for inclusion in a DCP, which is the only kind of content a cinema's equipment can play.

When any content within a DCP is changed, a new DCP must be created that contains the new content and any pre-existing content. DCPs are the only media format that cinema equipment is capable of playing, as a cinema's playlist cannot point to individual files, but rather identifies DCPs for playback. Creating a new DCP requires that all the CPLs and corresponding content be present and packaged into the DCP, and given the high fidelity requirements for a cinema, DCPs tend to be quite large. For example, a DCP corresponding to a set of pre-movie advertisements for a particular showing may be 8-12 GBs. The large file size of DCPs makes building and transferring DCPs a resource-intensive process.

Given their size and special formatting requirements, DCPs are built off cinema premises (e.g., off of cinema premises 100, in the example of FIG. 1). In other words, a cinema such as cinema 100 expects to receive DCPs in a finalized, ready-to-play format that can be processed by its theater management system (TMS), such as TMS 105. For example, DCPs corresponding to a movie are typically delivered to a particular cinema on specialized hard drives that contain the DCP, or over a specialized electronic distribution network that transmits movie DCPs over a proprietary satellite network to proprietary servers at the cinema. As explained above, DCPs are created off-site for any given cinema, and the content for the DCP is determined well in advance of any particular showing. Once a cinema receives the DCPs for its showing, a TMS coordinates the delivery and playback of content for all showings on the screens in that cinema and transmits the appropriate DCPs as identified by a playlist for a particular showing to the corresponding digital theater equipment for the screen that will display the showing.

DCPs that contain advertisements are not transmitted over the specialized network used to distribute movie DCPs. Transmitting DCPs that contain dynamic content using physical media such as hard drives is not feasible given the dynamic, near real-time nature of determining the content of a dynamic CPL slot in a DCP. Simply packing the DPC off-site at a supply-side platform is also not practical, as creating a DCP that contains a mix of static and dynamic advertisements would require (1) uploading the static content to a remote server, such as a server associated with an ad exchange or an intermediary that delivers content from the ad exchange to the cinema; (2) selecting the specific advertisements that will go into the dynamic slots for a specific DCP; (3) creating the new DCP containing the static content and the dynamic content; and (4) downloading the new DCP (including both the dynamic and static content) onto the cinema's TMS equipment so that the DCP can be distributed and played on a cinema screen. This process would have to be repeated each time a DCP contains dynamic content. As explained herein, the static content must be packaged with the dynamic content at the time the DCP is created in order to create a valid DCP, and therefore the static content must be sent to the cloud-based server that obtains the dynamically determined advertising content.

Moreover, of every pre-movie set of advertisements contained some dynamic content, each showing would require performing the four steps enumerated above. Given the high fidelity and number of screens in a cinema, the process would quickly become very resource intensive. For example, for a cinema that contains ten theaters, each with four showings per day, 40 DCPs per day would need to be uploaded and downloaded as described above. If each DCP is approximately 10 GB, then the four steps described above would take about 400 GB of download and upload bandwidth each day in order to obtain DCPs that contain dynamically determined advertising content. This process takes considerably bandwidth and significant time for the data transfers to occur. Moreover, as explained below, the process would in practice not be capable of including dynamically determined advertisements given the proof-of-performance requirements supply-side platforms impose.

FIG. 1 illustrates an example architecture for improving the packaging and delivery of certain digital cinema packages to a cinema. A cloud agent 130 (which, in particular embodiments, may be a cloud-based API) is connected to a local agent 120 at cinema premises 100. Local agent 120 is a process executing on one or more computing devices, such as a server device, that performs functions described herein. Likewise, cloud agent 130 is a process executing on one or more computing devices, such as a server device. Cloud agent 130 is connected to supply-side platform (SSP) 135, which provides dynamic content in the correct format (i.e., MXF files) as requested by cloud agent 130. The connections described herein may be any suitable wired or wireless network connections, such as connections that form part of the World Wide Web network.

Cloud agent 130 receives a pre-show playlist for cinema 100 that applies to a period of time, e.g., a weekly pre-show playlist. The playlist identifies the CPL slots for each showing at cinema 100. In the conventional approach, each CPL content slot would be filled with static content. However, the embodiments described herein enable mixing of static and dynamic content in a DCP, and therefore the pre-show playlist may identify DCPs or CPLs that contain unfilled slots, i.e., slots that require dynamic content.

Cloud agent 130 interfaces with SSP 135 to ultimately fill placeholder CPL slots with dynamic content, thereby providing cinema 100 with access to dynamic content, which is not available in the conventional approach. Cloud agent 130 periodically requests a list from SSP 135 of all dynamic content that may be provided to cinema 100 during a period of time. The period of time is often a day, but may be more or less. The request from cloud agent 130 may be made periodically, or may be a one-time, ongoing request for period updates from SSP 135. SSP 135 provides a list, or manifest, to cloud agent 130 of all the dynamic content items that may be provided to cinema 100 over the period of time. For example, SSP 135 may provide a manifest identifying all advertisements that may be provided to cinema 100 in order to fill a dynamic content spot in a DCP for a particular showing at cinema 100 during a particular day. The content SSP 135 may provide changes regularly, e.g., every day.

SSP 135 may be part of, or connected to, an ad exchange, which hosts an advertisement auction for advertisers. Advertisers may submit ads to SSP 135 to potentially place in open advertisement spots, along with bidding information for those advertisements. SSP 135 may host the ad exchange, and when a request for dynamic content is made, SSP 135 performs an auction for that spot and selects, based on the auction, an advertisement for placement.

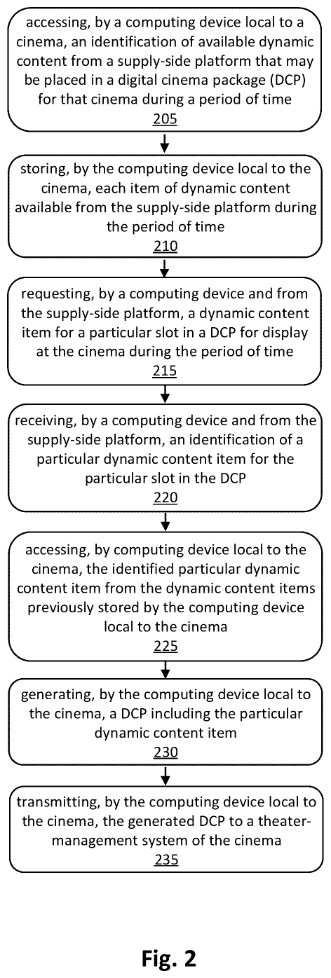

FIG. 2 illustrates an example method for improving the packaging and delivery of certain digital cinema packages to a cinema. Step 205 of the example method of FIG. 2 includes accessing, by a computing device local to a cinema, a manifest identifying available dynamic content from a supply-side platform that may be placed in a digital cinema package (DCP) for that cinema during a period of time. In the example of FIG. 1, the computing device local to the cinema may include local repository 115, local agent 120, and DCP builder 125, although this disclosure contemplates that those systems may be distributed across more than one computing device. In particular embodiments, cloud agent 130 will submit a request to SSP 135 for the manifest, and then transmit the manifest to local agent 120. In particular embodiments, step 205 of the example method of FIG. 2 may include submitting a request to an upstream component for the identification, for example by submitting a request to cloud agent 130 or to SSP 135. In particular embodiments, step 205 may include accessing an identification that is automatically provided, for example from an upstream component, to the computing device local to a cinema. In particular embodiments, the identification may be a manifest, as described above, identifying the advertisements that might be provided by an SSP to fulfill available advertising slots.

While the example of FIG. 1 illustrates cloud agent 130 as communicating directly with SSP 135, this disclosure contemplates that other intermediary computing devices or servers may be connected between those components. For example, in particular embodiments, an intermediary service provider may handle communications between cloud agent 130 and one more SSPs. In addition, while the example of FIG. 1 illustrates communication with a single SSP, this disclosure contemplates that a cinema may communicate, e.g., via local agent 120 and cloud agent 130, with multiple SSPs, and perform the example method of FIG. 2 for each SSP. Moreover, this disclosure contemplates that some or all of the functionality of cloud agent 130 may be performed by one or more computing devices local to cinema 100 or remote from cinema 100 (e.g., cloud agent 130 may be partially or entirely located on cinema premises 100, in particular embodiments).

Step 210 of the example method of FIG. 2 includes storing, by the computing device local to the cinema, each item of dynamic content identified in the manifest for that period of time. For instance, in the example of FIG. 1, the dynamic content identified in step 205 may be downloaded from SSP 135 and stored in a local repository, which is local to the cinema premises 100 and is hosted by a computing device connected to the cinema's network, e.g., to a network including TMS 105. Step 210 may include, for example, downloading and storing each advertisement in an MXF format in a local repository. In particular embodiments, existing content in the local repository that is not identified in the manifest from SSP 135 (e.g., existing advertisements that would not be used by SSP 135 during the current day) may be deleted from local repository 115.

Step 215 of the example method of FIG. 2 includes requesting, by a computing device and from the supply-side platform, a dynamic content item for a particular slot in a DCP for display at the cinema during the period of time. For example, in the context of FIG. 1, cloud agent 130 may determine that a particular slot (e.g., a slot for a particular pre-show advertisement) in a DCP is unfilled, i.e., needs to be filled by dynamic content. This determination may be based on the pre-show playlist described above. Cloud agent 130 may then request a dynamic content item from supply-side platform 135 to fill the particular slot in the DCP. The particular slot in the DCP referenced herein may be the only slot in the DCP—i.e., the DCP may contain only one slot (e.g., one CPL that contains one slot) for content—or the particular slot in the DCP may be one slot of multiple slots in the DCP (e.g., multiple CPLs with one or more slots, or one CPL with multiple slots, etc.).

In particular embodiments, cloud agent 130 may determine a time at which to perform step 215. A supply-side platform often imposes proof-of-performance requirements that require a confirmation that an advertisement was played to be sent to the supply-side platform (or to an associated advertiser) within some period of time of the SSP sending the advertisement. For example, when a supply-side platform receives a request for an advertisement, the supply-side platform may provide the advertisement along with a proof-of-performance URL that must be activated with a period of time, e.g., one hour, of sending the advertisement. As described above, the conventional DCP creation process for a cinema cannot meet these temporal requirements, and therefore dynamic content for a supply-side platform cannot be played on the cinema's theater equipment. In addition, the large sizes of DCPs and the requirement that all content be packaged in a valid DCP makes entirely cloud-based solutions impractical for meeting these temporal requirements, as the request for dynamic content from the supply-side platform should happen relatively near the time the dynamic content is played (to meet the proof-of-performance requirements), while the network resources required to send existing static content offsite and receive a fully-formed DCP containing the static and dynamic content back at the cinema make such short timeframes impractical to reliably obtain. However, as explained herein, the example method of FIG. 2 makes possible inclusion of such dynamic content in DCPs to be played by cinema equipment. Cloud agent 130 may determine the time at which to perform step 215 by making the request very close in time to the playback of the content items (e.g., within an hour, or even less, of playback). Cloud agent 130 may make this determination by determining the time a movie associated with the pre-show DLC will play. Then, when the difference between the current time and the time at which the movie will play is less than a predetermined threshold (e.g., less than one hour), cloud agent 130 may determine that it is time to perform step 215.

Step 220 of the example method of FIG. 2 includes receiving, by a computing device and from the supply-side platform, an identification of a particular dynamic content item for the particular slot in the DCP. For instance, in the example of FIG. 1, SSP 135 may hold an auction for a particular slot (which auction may have occurred some time before the request or in response to the request) and provide an identification of the winning advertisement to cloud agent 130. The identification may be made by, for example, transmitting to cloud agent 130 an ID associated with a particular advertisement previously identified on a manifest provided by SSP 135.

Step 225 of the example method of FIG. 2 includes accessing, by computing device local to the cinema, the identified particular dynamic content item from the dynamic content items previously stored by the computing device local to the cinema. For instance, in the example of FIG. 1, cloud agent 130 may receive an identification of the dynamic content item from SSP 135, and then may update the corresponding DCP (and/or CPL(s)) with the identification of the dynamic content item to fill in the placeholder slot. In particular embodiments, when a DCP or CPL contains multiple unfilled slots, then steps 215-220 may be performed for each of those unfilled slots. Cloud agent 130 then provides the complete CPL to local agent 120, which retrieves the identification dynamic content items from local repository 115. As these content items were downloaded earlier, the retrieval process takes negligible time, even though the content files involved may be quite large.

Step 230 of the example method of FIG. 2 includes generating, by the computing device local to the cinema, a DCP including the particular dynamic content item. For instance, in the example of FIG. 1, a DCP builder 125 may be used to create a new DCP that contains the dynamic content items and the previously identified static content items for the DCP, i.e., a DCP that contains all the content items as identified by the completed CPL provided by cloud agent 130. DCP builder 125 generates a new DCP with new metadata (e.g., timestamp). The new DCP contains new CPLs and previously identified CPLs, each corresponding to new, dynamic content and previously identified static content, respectively.

Once the new DCP is built, step 235 of the example method of FIG. 2 includes transmitting, by the computing device local to the cinema, the generated DCP to a theater-management system of the cinema. For example, local agent 120 may transmit the new, complete DCP to TMS 105, which can then transmit the DCP to the appropriate screen(s) during the showing(s) identified by the playlist of TMS 105. In particular embodiments, after playing the advertisement, cinema 100 may submit a proof-of-performance to SSP 135 to validate that the advertisement was played in the assigned DCP slot. As explained above, this proof-of-performance validation can occur within the relatively stringent timelines required by SSP 135, even though the file sizes involved are quite large, given the high-fidelity requirements of theater cinema equipment. In addition, the dynamic content is played on the cinema's theater equipment and is identified in a DCP, in contrast to certain existing methods that require manually switching a screen's input from the cinema's digital equipment to a different input that plays, e.g., lower-quality .MP4 content.

Particular embodiments may repeat one or more steps of the method of FIG. 2, where appropriate. Although this disclosure describes and illustrates particular steps of the method of FIG. 2 as occurring in a particular order, this disclosure contemplates any suitable steps of the method of FIG. 2 occurring in any suitable order. Moreover, although this disclosure describes and illustrates particular components, devices, or systems carrying out particular steps of the method of FIG. 2, this disclosure contemplates any suitable combination of any suitable components, devices, or systems carrying out any suitable steps of the method of FIG. 2. Moreover, this disclosure contemplates that some or all of the computing operations described herein, including certain steps of the example method illustrated in FIG. 2, may be performed by circuitry of a computing device as described herein, by a processor coupled to non-transitory computer readable storage media, or any suitable combination thereof.

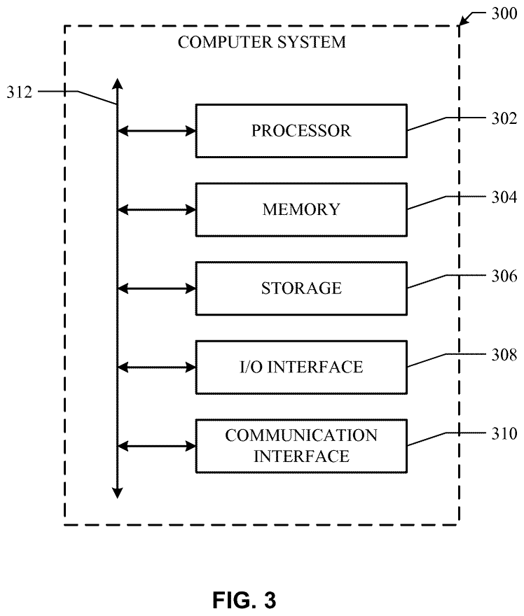

FIG. 3 illustrates an example computer system 300. In particular embodiments, one or more computer systems 300 perform one or more steps of one or more methods described or illustrated herein. In particular embodiments, one or more computer systems 300 provide functionality described or illustrated herein. In particular embodiments, software running on one or more computer systems 300 performs one or more steps of one or more methods described or illustrated herein or provides functionality described or illustrated herein. Particular embodiments include one or more portions of one or more computer systems 300. Herein, reference to a computer system may encompass a computing device, and vice versa, where appropriate. Moreover, reference to a computer system may encompass one or more computer systems, where appropriate.

This disclosure contemplates any suitable number of computer systems 300. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 300 may include one or more computer systems 300; be unitary or distributed; span multiple locations; span multiple machines; span multiple data centers; or reside in a cloud, which may include one or more cloud components in one or more networks. Where appropriate, one or more computer systems 300 may perform without substantial spatial or temporal limitation one or more steps of one or more methods described or illustrated herein. As an example and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate.

In particular embodiments, computer system 300 includes a processor 302, memory 304, storage 306, an input/output (I/O) interface 308, a communication interface 310, and a bus 312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 302 includes hardware for executing instructions, such as those making up a computer program. As an example and not by way of limitation, to execute instructions, processor 302 may retrieve (or fetch) the instructions from an internal register, an internal cache, memory 304, or storage 306; decode and execute them; and then write one or more results to an internal register, an internal cache, memory 304, or storage 306. In particular embodiments, processor 302 may include one or more internal caches for data, instructions, or addresses. This disclosure contemplates processor 302 including any suitable number of any suitable internal caches, where appropriate. As an example and not by way of limitation, processor 302 may include one or more instruction caches, one or more data caches, and one or more translation lookaside buffers (TLBs). Instructions in the instruction caches may be copies of instructions in memory 304 or storage 306, and the instruction caches may speed up retrieval of those instructions by processor 302. Data in the data caches may be copies of data in memory 304 or storage 306 for instructions executing at processor 302 to operate on; the results of previous instructions executed at processor 302 for access by subsequent instructions executing at processor 302 or for writing to memory 304 or storage 306; or other suitable data. The data caches may speed up read or write operations by processor 302. The TLBs may speed up virtual-address translation for processor 302. In particular embodiments, processor 302 may include one or more internal registers for data, instructions, or addresses. This disclosure contemplates processor 302 including any suitable number of any suitable internal registers, where appropriate. Where appropriate, processor 302 may include one or more arithmetic logic units (ALUs); be a multi-core processor; or include one or more processors 302. Although this disclosure describes and illustrates a particular processor, this disclosure contemplates any suitable processor.

In particular embodiments, memory 304 includes main memory for storing instructions for processor 302 to execute or data for processor 302 to operate on. As an example and not by way of limitation, computer system 300 may load instructions from storage 306 or another source (such as, for example, another computer system 300) to memory 304. Processor 302 may then load the instructions from memory 304 to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to memory 304. In particular embodiments, processor 302 executes only instructions in one or more internal registers or internal caches or in memory 304 (as opposed to storage 306 or elsewhere) and operates only on data in one or more internal registers or internal caches or in memory 304 (as opposed to storage 306 or elsewhere). One or more memory buses (which may each include an address bus and a data bus) may couple processor 302 to memory 304. Bus 312 may include one or more memory buses, as described below. In particular embodiments, one or more memory management units (MMUs) reside between processor 302 and memory 304 and facilitate accesses to memory 304 requested by processor 302. In particular embodiments, memory 304 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 304 may include one or more memories 304, where appropriate. Although this disclosure describes and illustrates particular memory, this disclosure contemplates any suitable memory.

In particular embodiments, storage 306 includes mass storage for data or instructions. As an example and not by way of limitation, storage 306 may include a hard disk drive (HDD), a floppy disk drive, flash memory, an optical disc, a magneto-optical disc, magnetic tape, or a Universal Serial Bus (USB) drive or a combination of two or more of these. Storage 306 may include removable or non-removable (or fixed) media, where appropriate. Storage 306 may be internal or external to computer system 300, where appropriate. In particular embodiments, storage 306 is non-volatile, solid-state memory. In particular embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 may include one or more storage control units facilitating communication between processor 302 and storage 306, where appropriate. Where appropriate, storage 306 may include one or more storages 306. Although this disclosure describes and illustrates particular storage, this disclosure contemplates any suitable storage.

In particular embodiments, I/O interface 308 includes hardware, software, or both, providing one or more interfaces for communication between computer system 300 and one or more I/O devices. Computer system 300 may include one or more of these I/O devices, where appropriate. One or more of these I/O devices may enable communication between a person and computer system 300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, I/O interface 308 may include one or more device or software drivers enabling processor 302 to drive one or more of these I/O devices. I/O interface 308 may include one or more I/O interfaces 308, where appropriate. Although this disclosure describes and illustrates a particular I/O interface, this disclosure contemplates any suitable I/O interface.

In particular embodiments, communication interface 310 includes hardware, software, or both providing one or more interfaces for communication (such as, for example, packet-based communication) between computer system 300 and one or more other computer systems 300 or one or more networks. As an example and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. As an example and not by way of limitation, computer system 300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 300 may include any suitable communication interface 310 for any of these networks, where appropriate. Communication interface 310 may include one or more communication interfaces 310, where appropriate. Although this disclosure describes and illustrates a particular communication interface, this disclosure contemplates any suitable communication interface.

In particular embodiments, bus 312 includes hardware, software, or both coupling components of computer system 300 to each other. As an example and not by way of limitation, bus 312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 312 may include one or more buses 312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing, by a computing device local to a cinema, a manifest identifying dynamic content from a supply-side platform that may be placed in a digital cinema package (DCP) for that cinema during a period of time;
storing, by the computing device local to the cinema, each item of dynamic content identified in the manifest for that period of time;
requesting, by a computing device and from the supply-side platform, a dynamic content item for a particular slot in a DCP for display at the cinema during the period of time;
receiving, by a computing device and from the supply-side platform, an identification of a particular dynamic content item for the particular slot in the DCP;
accessing, by computing device local to the cinema, the identified particular dynamic content item from the dynamic content items previously stored by the computing device local to the cinema;
generating, by the computing device local to the cinema, a DCP including the particular dynamic content item; and
transmitting, by the computing device local to the cinema, the generated DCP to a theater-management system of the cinema.

2. The method of claim 1, wherein storing each item of dynamic content available from the supply-side platform during the period of time comprises, for each item of dynamic content:
determining whether that item of dynamic content is stored by the computing device local to the cinema; and
when that item of dynamic content is not stored by the computing device local to the cinema, then downloading, from the supply-side platform, that item of dynamic content.

3. The method of claim 2, further comprising removing, from the computing device local to the cinema, any dynamic content item that is not identified in the accessed identification of available dynamic content.

4. The method of claim 1, wherein the period of time comprises a day.

5. The method of claim 1, wherein the dynamic content item for the particular slot comprises an advertisement.

6. The method of claim 1, further comprising determining, by a computing device, a time at which to request from the supply-side platform the dynamic content item for the particular slot in the DCP for display at the cinema during the period of time.

7. The method of claim 6, further comprising:
determining a particular time at which a movie associated with the DCP will play at the cinema;
in response to a determination that a difference between the current time and the particular time is less than a predetermined threshold, then requesting the dynamic content item for the particular slot in the DCP.

8. A system comprising: one or more non-transitory computer-readable storage media including instructions; and one or more processors coupled to the storage media, the one or more processors configured to execute the instructions to:
access, by a computing device local to a cinema, a manifest identifying dynamic content from a supply-side platform that may be placed in a digital cinema package (DCP) for that cinema during a period of time;
store, by the computing device local to the cinema, each item of dynamic content identified in the manifest for that period of time;
access, by computing device local to the cinema, an identified particular dynamic content item from the dynamic content items previously stored by the computing device local to the cinema, wherein the identified particular dynamic content item is identified by the supply-side platform in response to a request for a dynamic content item for the particular slot in the DCP for display at the cinema during the period of time;
generate, by the computing device local to the cinema, a DCP including the particular dynamic content item; and
transmit, by the computing device local to the cinema, the generated DCP to a theater-management system of the cinema.

9. The system of claim 8, wherein the processors are further configured to execute the instructions to, for each item of dynamic content:
determine whether that item of dynamic content is stored by the computing device local to the cinema; and
when that item of dynamic content is not stored by the computing device local to the cinema, then download, from the supply-side platform, that item of dynamic content.

10. The system of claim 9, wherein the processors are further configured to execute the instructions to remove, from the computing device local to the cinema, any dynamic content item that is not identified in the accessed identification of available dynamic content.

11. The system of claim 8, wherein the period of time comprises a day.

12. The system of claim 8, wherein the dynamic content item for the particular slot comprises an advertisement.

13. The system of claim 8, further comprising a cloud agent comprising one or more non-transitory computer-readable storage media including instructions; and one or more processors coupled to the storage media, the one or more processors configured to execute the instructions to determine a time at which to request from the supply-side platform the dynamic content item for the particular slot in the DCP for display at the cinema during the period of time

14. The system of claim 13, wherein the one or more processors of the cloud agent are further configured to execute the instructions of the cloud agent to:
determine a particular time at which a movie associated with the DCP will play at the cinema;
in response to a determination that a difference between the current time and the particular time is less than a predetermined threshold, then request the dynamic content item for the particular slot in the DCP.

15. One or more non-transitory computer-readable media comprising instructions that, when executed by one or more processors of a computing system, cause the one or more processors to:
access, by a computing device local to a cinema, a manifest identifying dynamic content from a supply-side platform that may be placed in a digital cinema package (DCP) for that cinema during a period of time;
store, by the computing device local to the cinema, each item of dynamic content identified in the manifest for that period of time;
access, by computing device local to the cinema, an identified particular dynamic content item from the dynamic content items previously stored by the computing device local to the cinema, wherein the identified particular dynamic content item is identified by the supply-side platform in response to a request for a dynamic content item for the particular slot in the DCP for display at the cinema during the period of time;
generate, by the computing device local to the cinema, a DCP including the particular dynamic content item; and
transmit, by the computing device local to the cinema, the generated DCP to a theater-management system of the cinema.

16. The media of claim 15, wherein the processors are further configured to execute the instructions to, for each item of dynamic content:
determine whether that item of dynamic content is stored by the computing device local to the cinema; and
when that item of dynamic content is not stored by the computing device local to the cinema, then download, from the supply-side platform, that item of dynamic content.

17. The media of claim 16, wherein the processors are further configured to execute the instructions to remove, from the computing device local to the cinema, any dynamic content item that is not identified in the accessed identification of available dynamic content.

18. The media of claim 15, wherein the period of time comprises a day.

19. The media of claim 15, wherein the dynamic content item for the particular slot comprises an advertisement.
